(19) United States
(12) Patent Application Publication
(10) Pub. No.: US 2017/0105023 A1
(43) Pub. Date: Apr. 13, 2017

(54) SIGNALING OF UPDATED VIDEO REGIONS

(71) Applicant: QUALCOMM Incorporated, San Diego, CA (US)

(72) Inventors: Dileep Marchya, Hyderabad (IN); Mastan Manoj Kumar Amara Venkata, San Diego, CA (US); Ye-Kui Wang, San Diego, CA (US); Rajan Laxman Joshi, San Diego, CA (US); Sudeep Ravi Kottilingal, San Diego, CA (US)

(21) Appl. No.: 15/287,007

(22) Filed: Oct. 6, 2016

Related U.S. Application Data
(60) Provisional application No. 62/239,228, filed on Oct. 8, 2015.

(51) Int. Cl. H04N 19/55; H04N 19/17

(52) U.S. Cl. CPC H04N 19/55; H04N 19/17; H04L 65/608

(57) ABSTRACT

A device and method of decoding video data that includes decoding the video data to generate decoded video data of a current frame of the video data, and extracting an updated regions message from the decoded video data and determining updated region location information of the current frame based on the updated regions message. An updated region of the current frame is identified based on the updated region location information, the updated region being less than a total size of the current frame, and both the identified updated region and decoded video data of the current frame that has not been updated are transmitted for display of the current frame of the video data.

This application claims the benefit of U.S. Provisional Application No. 62/239,228, filed Oct. 8, 2015, the entire contents of which are hereby incorporated by reference.

### TECHNICAL FIELD

This disclosure relates to video coding (i.e., encoding and/or decoding) of video data.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for signaling indications of regions of a picture that have been updated by a subsequent picture. By signaling regions of a picture that have been updated, a display device (or a frame composition device) may avoid updating non-updated regions of a display, e.g., by repeating data for the non-updated regions based on previously displayed image data. A source device, such as a video encoder, may encode signaling data that indicates which regions are updated, e.g., in a supplemental enhancement information (SEI) message. A client device, such as a video decoder, may retrieve the signaling data and pass the signaling data to a display device and/or a frame composition device.

In one example, a method of decoding video data comprises decoding the video data to generate decoded video including a current frame; extracting an updated regions message from the video data; determining updated region location information of the current frame based on the updated regions message; and outputting the updated region location information and the current frame.

In another example, a device for decoding video data comprises a memory configured to store video data; and a video decoder comprising one or more processors implemented in digital logic circuitry, the video decoder configured to decode the video data to generate decoded video data including a current frame; extract an updated regions message from the video data; determine updated region location information of the current frame based on the updated regions message; and output the updated region location information and the current frame.

In another example, a computer-readable medium, such as a non-transitory computer-readable storage medium, has stored thereon instructions that, when executed, cause one or more processors to decode the video data to generate decoded video data of a current frame of the video data; extract an updated regions message from the decoded video data and determining updated region location information of the current frame based on the updated regions message; identify an updated region of the current frame based on the updated region location information, the updated region being less than a total size of the current frame; and transmit both the identified updated region and the decoded video data of the current frame.

In another example, a device for generating a frame to be displayed comprises a memory configured to buffer video data for one or more frames; and one or more processors comprising digital logic circuitry, the processors being configured to store a previous frame to the memory; receive a current frame from a video decoder; receive updated region location information from the video decoder; generate a frame including an updated region from the current frame identified by the updated region location information and a repeated region from the previous frame that is outside of the updated region; and store the generated frame to the memory to cause the generated frame to be sent to a display.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may be configured or otherwise operable to implement or otherwise utilize one or more techniques described in this disclosure.

FIG. 2 is a block diagram illustrating an example of a video encoder that may be configured or otherwise operable to implement or otherwise utilize one or more techniques described in this disclosure.

FIG. 3 is a block diagram illustrating an example of a video decoder that may be configured or otherwise operable to implement or otherwise utilize one or more techniques described in this disclosure.

FIG. 4 is a block diagram illustrating an example of a display device that may implement techniques for displaying video data, in accordance with one or more aspects of this disclosure.

FIGS. 5A and 5B are block diagrams illustrating identifying an updated region of a current frame in accordance with techniques of the present disclosure.

FIG. 6 illustrates an example approach for conveying information used by a destination device, such as a smart display panel, to display only the updated portions of a frame in accordance with one or more techniques described in this disclosure.

FIG. 7 illustrates an example video source with a frame having a single updated region outputting video information to a destination device having a display device in accordance with one or more techniques described in this disclosure.

FIG. 8 illustrates another example video source with a frame having a single updated region outputting video information to a destination device having a display device in accordance with one or more techniques described in this disclosure.

FIG. 9 is a flowchart illustrating an example approach for outputting information indicating a location of an updated region in a frame in accordance with one or more techniques described in this disclosure.

FIG. 10 is a flowchart illustrating an example approach for displaying updated regions of a frame in accordance with one or more techniques described in this disclosure.

FIG. 11 is a flow chart of a method of decoding video data in accordance with techniques of the present disclosure.

FIG. 12 is a flowchart of a method of generating a display by a display device in accordance with techniques of the present disclosure.

### DETAILED DESCRIPTION

This disclosure describes various techniques for updating portions of a frame on a smart display panel. In some applications, a source may only need to transmit a portion of the frame to a display. Smart display panels are capable of composing partial frames; this capability can be used to compose, within the smart display panel, only the updated regions of a video frame. But current video encoding techniques cannot be used to update portions of a smart display panel; the coded video signal is missing information that would help the smart display panel to display the updated regions.

For example, in screen sharing, screen recording, and wireless mirroring (e.g., games), only user interface (UI) layers may be encoded and transmitted to the smart display panel. In many instances, UI layers tend to have one or more small updated regions. Currently, there is no mechanism for transmitting the updated regions to the smart display panels. Therefore, the smart display panel must continuously compose a full video layer when only small regions are updated. This leads to inefficient utilization of hardware resources.

The various techniques described herein for updating portions of a frame on a smart display panel may be used in the context of advanced video codecs, such as extensions of HEVC or in the next generation of video coding standards. Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions. An international standard for video coding named High Efficiency Video Coding (HEVC) was recently developed by the Joint Collaborative Team on Video Coding (JCT-VC) of ITU-T WP3/16 and ISO/IEC JTC 1/SC 29/WG 11. The latest HEVC specification, and referred to as the HEVC spec hereinafter, is available from http://www.itu.int/rec/T-REC-H.265.

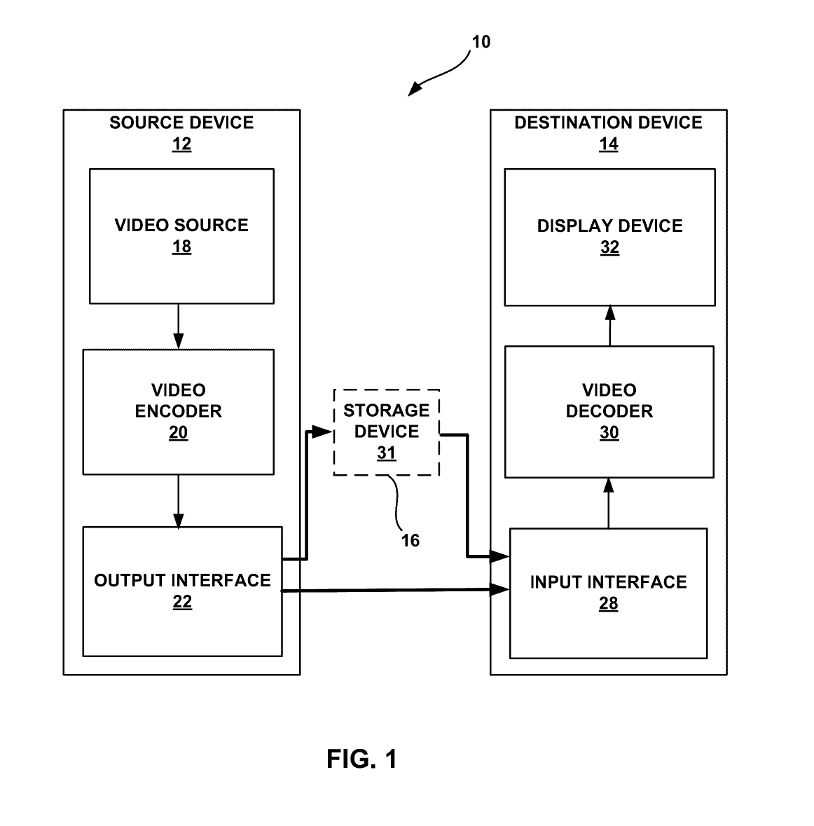

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium used to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 31. Similarly, encoded data may be accessed from storage device 31 by input interface. Storage device 31 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 31 may correspond to a file server or another intermediate storage device that may hold the encoded video generated by source device 12. Destination device 14 may access stored video data from storage device 31 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 31 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 31 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 31, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device. In some example approaches, destination device 14 is a smart display panel housing a display device 32.

In accordance with the techniques of this disclosure, video source 18 and/or video encoder 20 may be configured to determine which portions of a picture to be displayed by display device 32 of destination device 14 have been updated. For example, video source 18 may be configured to capture or generate data to be displayed within a defined user interface window by display device 32, where other data displayed by display device 32 is not to be updated. Additionally or alternatively, certain portions of video data to be encoded by video encoder 20 may be unchanged, such as background data or unchanged user interface elements. Thus, video encoder 20 may automatically determine whether data has changed (e.g., using motion estimation and/or motion compensation), and when data for, e.g., one or more blocks of video data remain unchanged between pictures, video encoder 20 may generate data indicating which portions of an encoded picture are changed and which portions are unchanged. Additionally or alternatively, source device 12 may include one or more user interfaces by which a user may manually define regions of a picture that are updated.

Furthermore, video encoder 20 may be configured to generate data to be included in a bitstream including encoded video data representing updated portions of pictures of the bitstream. Coded video segments of the bitstream may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, coding unit (CU), and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture, hence coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) messages may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

In accordance with the techniques of this disclosure, video encoder 20 may form SEI messages including updated regions information for one or more pictures. For example, video encoder 20 may determine which regions of an encoded picture are updated, that is, include distinct data relative to a previously encoded picture. As discussed above, video encoder 20 may determine the updated regions automatically and/or from received user input. Video encoder 20 may then form the SEI message to include data representing the updated region(s) of a corresponding picture (or corresponding set of pictures if the SEI message represents more than one picture).

For example, an updated region may be defined as a rectangle within a picture. Video encoder 20 may determine vertices for an updated region, and construct an SEI message including data representing each of the four vertices of the rectangle for the updated region, e.g., {(x1, y1), (x2, y1), (x1, y2), (x2, y2)}, where {x1, x2} and {y1, y2} are within the boundaries of the picture. In this example, the x1 and x2 values may define horizontal coordinates of the vertices, while the y1 and y2 values may define vertical coordinates of the vertices. Video encoder 20 may determine one or multiple updated regions for one or more pictures, and construct the SEI message to represent each of the updated regions. In another example, the updated regions may be manually defined by a user via one or more user interface.

Similarly, video decoder 30 may be configured to process such SEI messages. In particular, video decoder 30 may decode encoded frames, and receive accompanying SEI messages for one or more of the frames. Video decoder 30 may extract updated regions information from the SEI messages, which again, may define vertices of one or more rectangular regions of one or more decoded frames that are updated, relative to a previous frame in display order. That is, the data of the SEI message may indicate that an updated region of a current frame is distinct from the previous frame in display order. Data outside of the updated region may be replayed from a previously displayed frame.

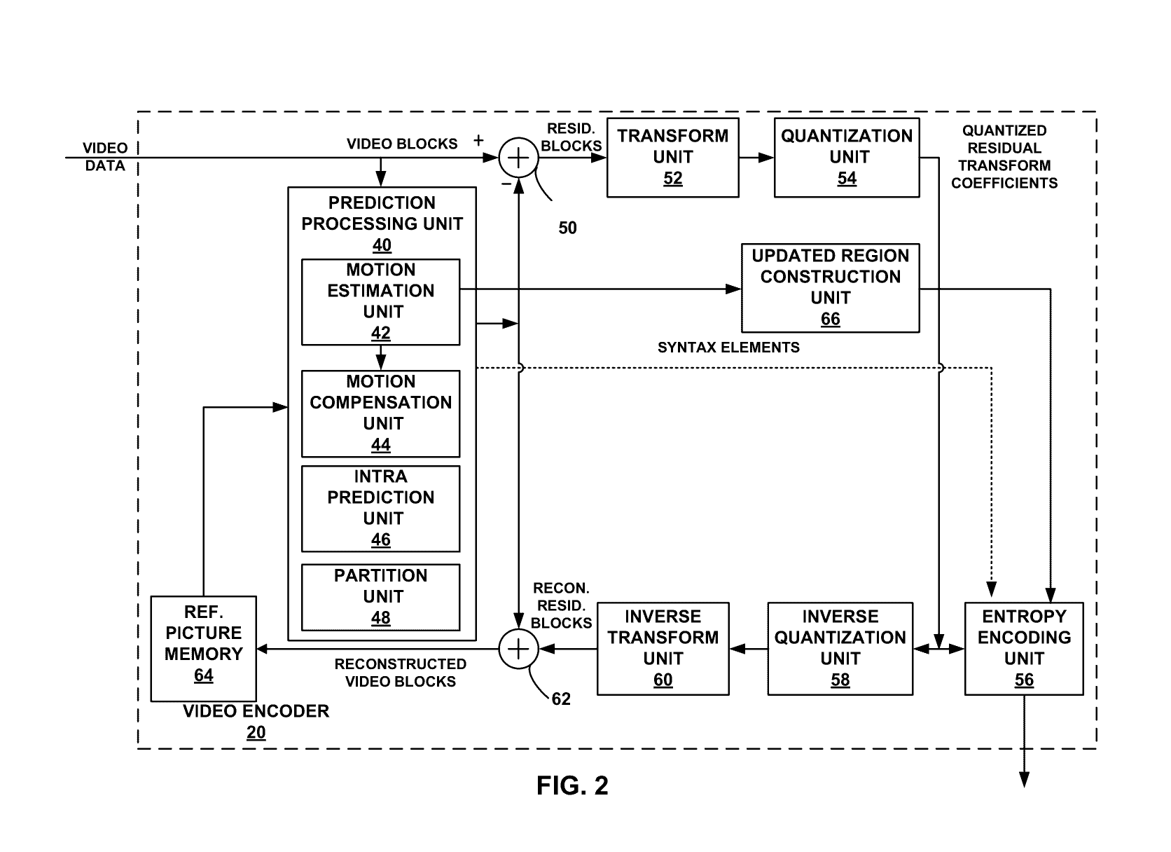

Video decoder 30 may be configured to extract the updated region location information (e.g., the vertices defining one or more updated regions) from the SEI messages included in a bitstream that also includes the encoded video data. Video decoder 30 may then convert the extracted updated region location information to a different format that is usable by display device 32. Display device 32 may include a frame composition unit, as discussed in greater detail with respect to FIG. 2 below, and therefore, display device 32 may also be referred to as a frame composition device. In particular, display device 32 may be configured to generate (or compose) a frame including data from a previous frame in display order (that has not been updated in a current frame) and data from the current frame in display order (that has been updated relative to the previous frame).

More particularly, display device 32 (or in some examples, an intermediate frame composition unit, not shown in the example of FIG. 1) may generate a frame to be displayed. To generate the frame, display device 32 may receive a decoded current frame and updated region location information from video decoder 30. Display device 32 may also include a frame buffer from which frames are retrieved to be displayed. Display device 32 may store video data from the decoded current frame included in the updated region identified by the updated region location information to the frame buffer, and video data from areas outside of the updated region from a previous frame (in display order) to the frame buffer. In this manner, a generated frame may include both data from the decoded current frame (specifically, for the updated region) as well as data from the previous frame (for regions outside the updated region). Thus, display device 32 may ultimately display this generated frame.

Video encoder 20 and video decoder 30 may operate according to a video compression standard, such as the High Efficiency Video Coding (HEVC) standard, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The HEVC standard is based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU may include a luma coding block and two chroma coding blocks. The CU may have associated prediction units (PUs) and transform units (TUs). Each of the PUs may include one luma prediction block and two chroma prediction blocks, and each of the TUs may include one luma transform block and two chroma transform blocks. Each of the coding blocks may be partitioned into one or more prediction blocks that comprise blocks to samples to which the same prediction applies. Each of the coding blocks may also be partitioned in one or more transform blocks that comprise blocks of sample on which the same transform is applied.

A size of the CU generally corresponds to a size of the coding node and is typically square in shape. The size of the CU may range from 8×8 pixels up to the size of the treeblock with a maximum of 64×64 pixels or greater. Each CU may define one or more PUs and one or more TUs. Syntax data included in a CU may describe, for example, partitioning of the coding block into one or more prediction blocks. Partitioning modes may differ between whether the CU is skip or direct mode encoded, intra-prediction mode encoded, or inter-prediction mode encoded. Prediction blocks may be partitioned to be square or non-square in shape. Syntax data included in a CU may also describe, for example, partitioning of the coding block into one or more transform blocks according to a quadtree. Transform blocks may be partitioned to be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may represent the TUs. Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more TUs. Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. The residual data may correspond to pixel differences between pixels of the unencoded picture and prediction values corresponding to the CUs. Video encoder 20 may form the residual data for the CU, and then transform the residual data to produce transform coefficients.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

FIG. 2 is a block diagram illustrating an example of video encoder 20 that may implement techniques for encoding video data, in accordance with one or more aspects of this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes prediction processing unit 40, reference picture memory 64, summer 50, transform processing unit 52, quantization unit 54, updated region construction unit 66, and entropy encoding unit 56. Prediction processing unit 41, in turn, includes motion compensation unit 44, motion estimation unit 42, and intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 62 (as an in-loop filter).

During the encoding process, video encoder 20 receives a video frame or slice to be coded. The frame or slice may be divided into multiple video blocks by prediction processing unit 41. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Prediction processing unit 40 may further produce a quadtree data structure indicative of partitioning of an LCU into sub-CUs. Leaf-node CUs of the quadtree may include one or more PUs and one or more TUs.

Prediction processing unit 40 may select one of the coding modes, intra or inter, e.g., based on error results, and provides the resulting intra- or inter-coded block to summer 50 to generate residual block data and to summer 62 to reconstruct the encoded block for use as a reference frame. Prediction processing unit 40 also provides syntax elements, such as motion vectors, intra-mode indicators, partition information, and other such syntax information, to entropy encoding unit 56. Prediction processing unit 40 may select one or more inter-modes using rate-distortion analysis.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma coding blocks, and motion compensation unit 44 uses motion vectors calculated based on the luma coding blocks for both chroma coding blocks and luma coding blocks. Prediction processing unit 40 may also generate syntax elements associated with the video blocks and the video slice for use by video decoder 30 in decoding the video blocks of the video slice.

In one example of the present disclosure, motion estimation unit 42 determines whether only a portion of a current frame less than a full size of the current frame needs to be updated, and updated region construction unit 66 generates updated region location information that is conveyed to destination device 14 to enable destination device 14 to identify an updated region of the current frame corresponding to the portion of the frame less than the full size of the frame that only needs to be updated, as described below. The updated region location information generated by updated region construction unit 66 may be conveyed as part of the encoded video bitstream, in a picture level supplemental enhancement information (SEI) message, a slice header, a picture header, or a parameter set. Alternatively, the information may be conveyed as part of file format metadata according to the ISO base media file format, e.g., in a time metadata track. Further alternatively, the information may be conveyed as part of Real-time Transport Protocol (RTP) packets, such as in RTP header extensions or in RTP payload data in communications based on RTP. In one example, updated region construction unit 66 may receive data information related to an identified updated region directly from a user via one or more interface, or via an external source device.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or prediction processing unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from prediction processing unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

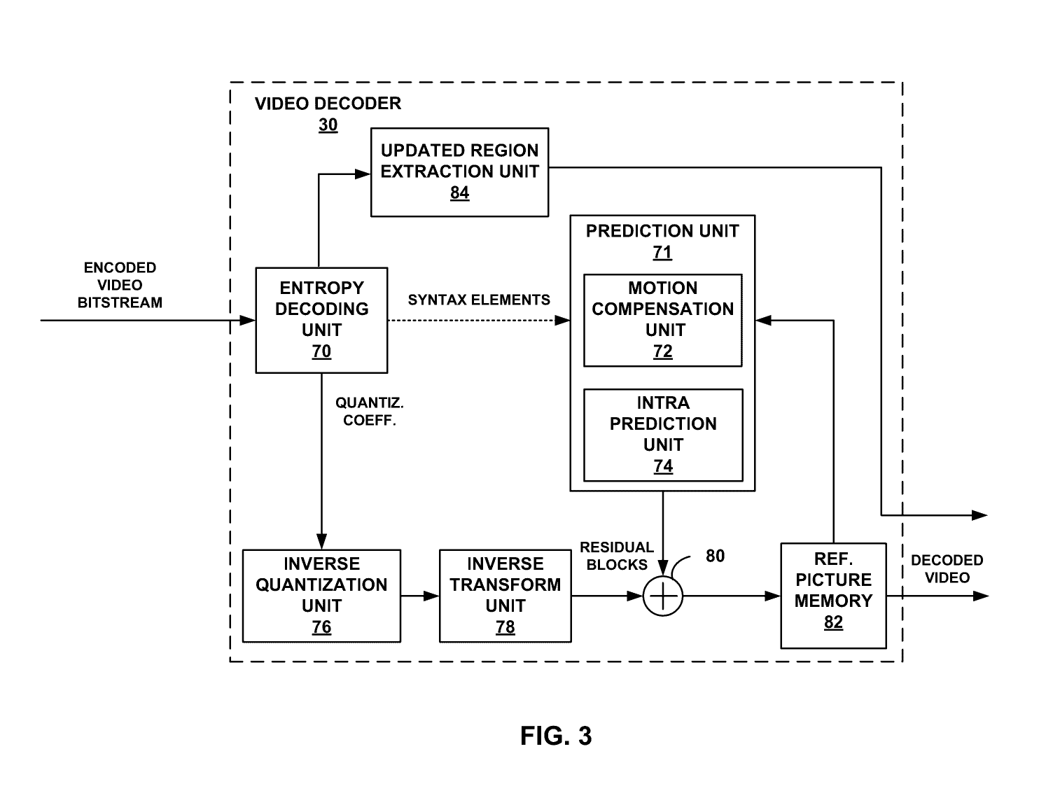

FIG. 3 is a block diagram illustrating an example of video decoder 30 that may implement techniques for decoding video data, in accordance with one or more aspects of this disclosure. In the example of FIG. 3, video decoder 30 includes an entropy decoding unit 70, motion compensation unit 72, intra prediction unit 74, inverse quantization unit 76, inverse transform unit 78, summer 80, reference picture memory 82, and updated region extraction unit 84. In the example of FIG. 3, video decoder 30 includes prediction unit 71, which, in turn, includes motion compensation unit 72 and intra prediction unit 74. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors and other syntax elements to motion compensation unit 72, and forwards updated region location information to updated region extraction unit 84. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de quantizes, the quantized transform coefficients provided in the bitstream and decoded by entropy decoding unit 70. The inverse quantization process may include use of a quantization parameter QPY calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1. As noted above, a source device 12 may only need to transmit an updated portion of a frame to a display. Smart display panels are capable of composing partial frames; this capability can be used to compose, within the smart display panel, only the updated regions of a video frame. But current video encoding techniques cannot be used to update portions of a smart display panel; the coded video signal is missing information that would help the smart display panel to display the updated regions. Therefore, the smart display panel must continuously compose a full video layer when only small regions are updated. This leads to inefficient utilization of hardware resources.

In accordance with an example of the present disclosure, updated region extraction unit 84 of video decoder 30 receives the updated region location information (e.g., generated by updated region construction unit 66 of video encoder 20 of FIG. 2), extracts the updated region information, and outputs (e.g., transmits) updated region location information for identifying one or more updated regions in the current frame to video display device 32, in addition to the decoded video block formed by the video decoder 30 by summing of the residual blocks from inverse transform unit 78 with the corresponding predictive blocks generated by motion compensation unit 72.

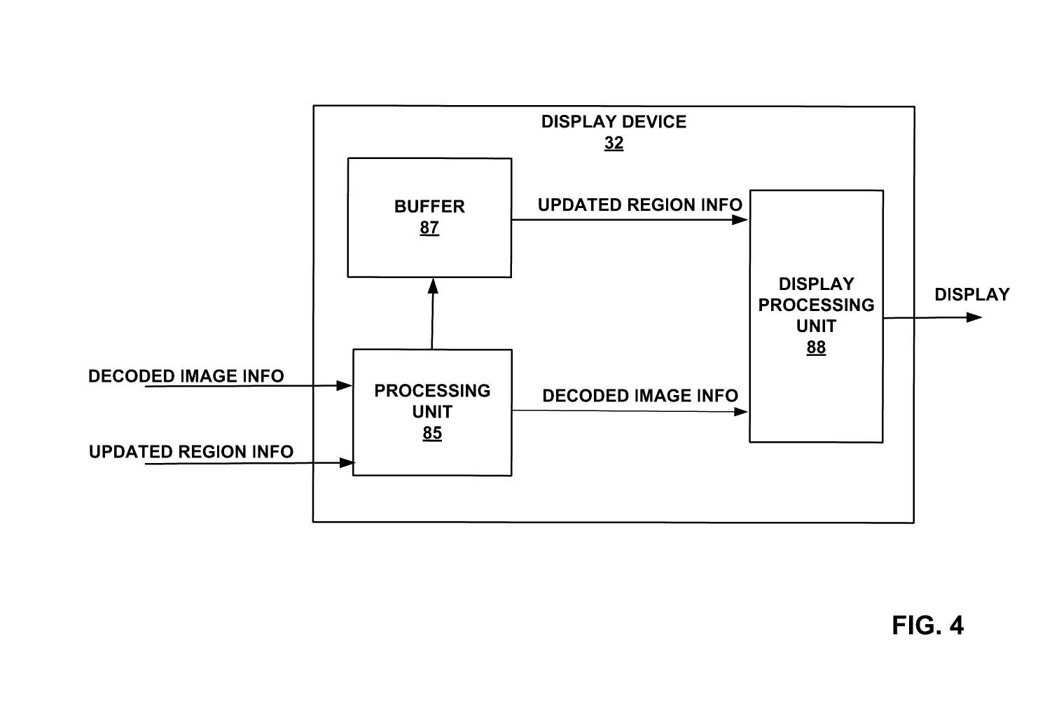

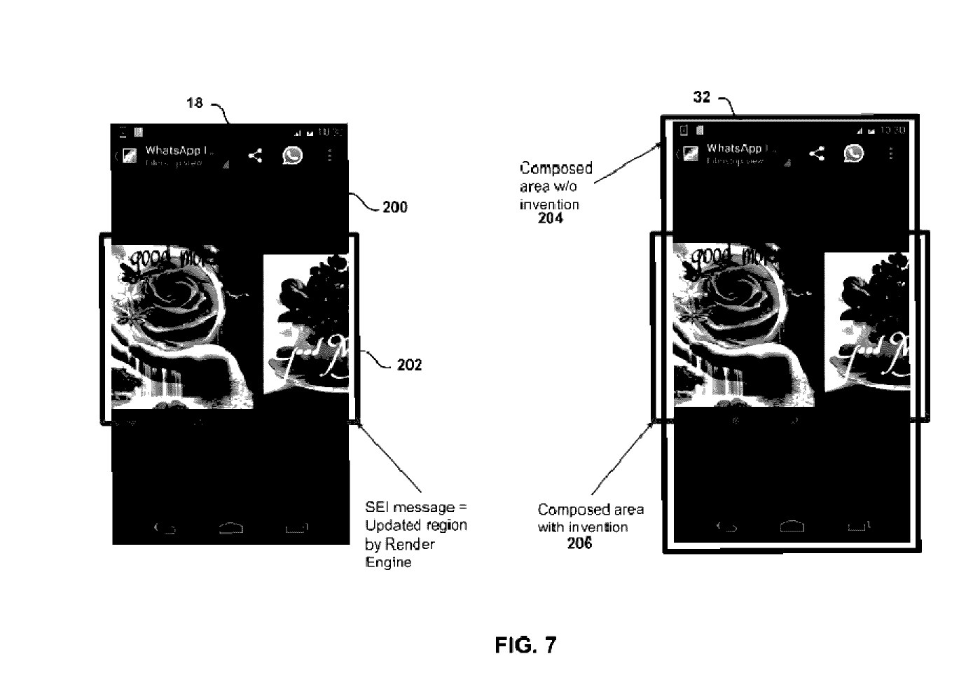

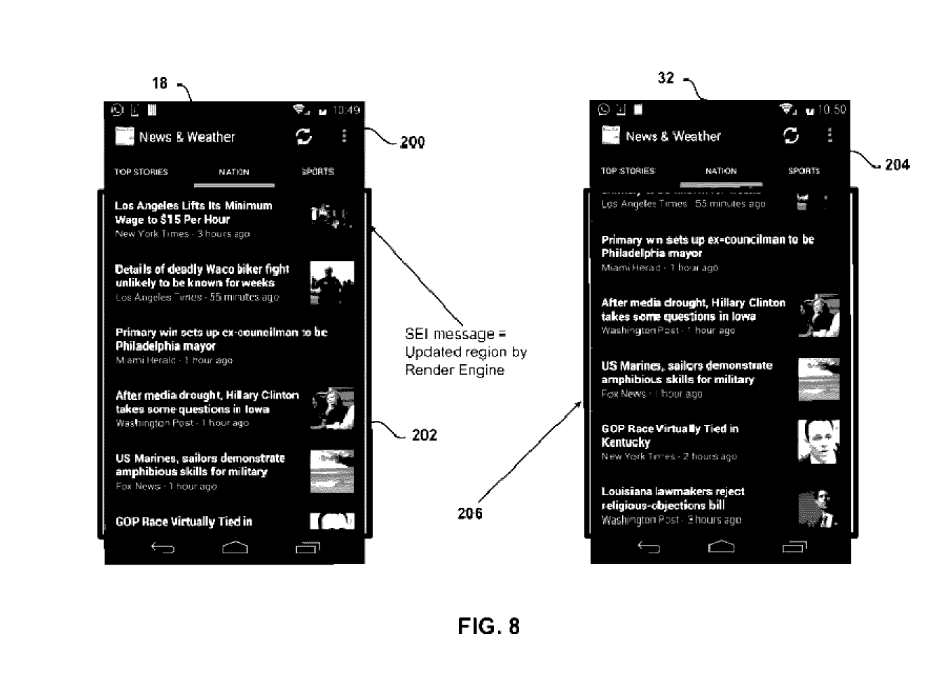

FIG. 4 is a block diagram illustrating an example of a display device that may implement techniques for displaying video data, in accordance with one or more aspects of this disclosure. As illustrated in FIG. 4, in one example, display device 32 may include a processing unit 85, a memory or buffer device 87, and a display processing unit 88. Processing unit 85 and display processing unit 88 may include one or more processors. In one example, processing unit 85 of display device 32 receives both the decoded image information for the current frame and the updated region information from the video decoder 30. Processing unit 85 separates the decoded image information and the updated region information by storing the updated region information within buffer 87. Display processing unit 88 receives both the decoded image information from processing unit 85 along with the updated region information from buffer 87, and generates a display of the current frame, having one or more resulting updated regions, as illustrated below in FIGS. 7 and 8 for example, based on the stored updated region information and the decoded image information.

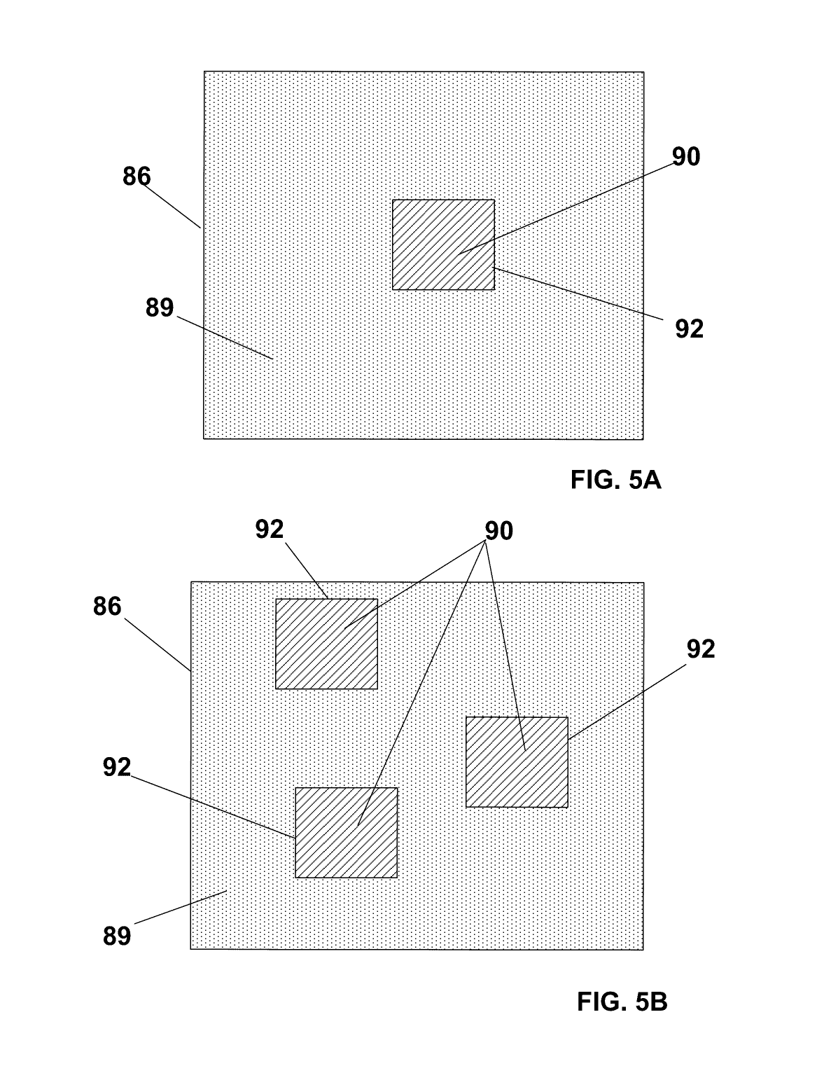

FIGS. 5A and 5B are block diagrams illustrating identifying an updated region of a current frame in accordance with techniques of the present disclosure. As illustrated in FIG. 5A, in one example of the present disclosure, during encoding of a current frame of the video data, motion estimation unit 42 of the video encoder 20 determines whether the current frame includes both a portion of the frame less than the full size of the frame that needs to be updated and a portion of the frame in which the content of the frame does not need to be updated. For example, a determination may be made as to whether the current frame 86 includes both a region that includes only zero-value motion vectors 89, i.e., motion vectors equal to zero, and a region that includes only non-zero value motion vectors 90, i.e., motion vectors not equal to zero. If both a region that includes only zero-value motion vectors 89 and a region that includes only non-zero value motion vectors 90 are not determined to be located within the current frame 86, an updated region is not identified. If there are both a region that includes only zero-value motion vectors 89 and a region that includes only non-zero value motion vectors 90 included within the current frame 86, a portion of the current frame 86 that includes only non-zero value motion vectors may be identified by updated region construction unit 66 as an updated region 92 region of the current frame 86, and the portion of the frame that includes only zero-value vectors may be identified as being the non-updated region of the current frame 86.

As illustrated in FIG. 5B, in one example of the present disclosure, in instances when there is both a region that includes only zero-value motion vectors 89 and a region that includes only non-zero value motion vectors 90 included within the current frame 86, more than one portion of the current frame 86 that includes only non-zero value motion vectors 90 may be determined by updated region construction unit 66 as an updated region 92 region of the current frame 86.

As described above in reference to FIG. 4, updated region extraction unit 84 of video decoder 30 receives the updated region location information generated by updated region construction unit 66 of video encoder 20, extracts the updated region information and transmits updated region placement information for identifying one or more updated regions in the current frame to video display device 32, in addition to the decoded video block formed by the video decoder 30 by summing of the residual blocks from inverse transform unit 78 with the corresponding predictive blocks generated by motion compensation unit 72.

Various techniques for identifying updated regions of a frame for generating a display for a display panel on a smart display panel will be discussed next. Although discussed with respect to a smart panel, the techniques may have application in other display or video coding settings, including settings with more conventional displays. As noted above, information that can be used by destination device 14 to display only the updated portions of a frame may be conveyed from source device 12 to destination device 14. For example, information may be conveyed as part of the encoded video bitstream, in a picture level supplemental enhancement information (SEI) message, a slice header, a picture header, or a parameter set. Alternatively, the information may be conveyed as part of file format metadata according to the ISO base media file format, e.g., in a time metadata track. Further alternatively, the information may be conveyed as part of Real-time Transport Protocol (RTP) packets, such as in RTP header extensions or in RTP payload data in communications based on RTP.

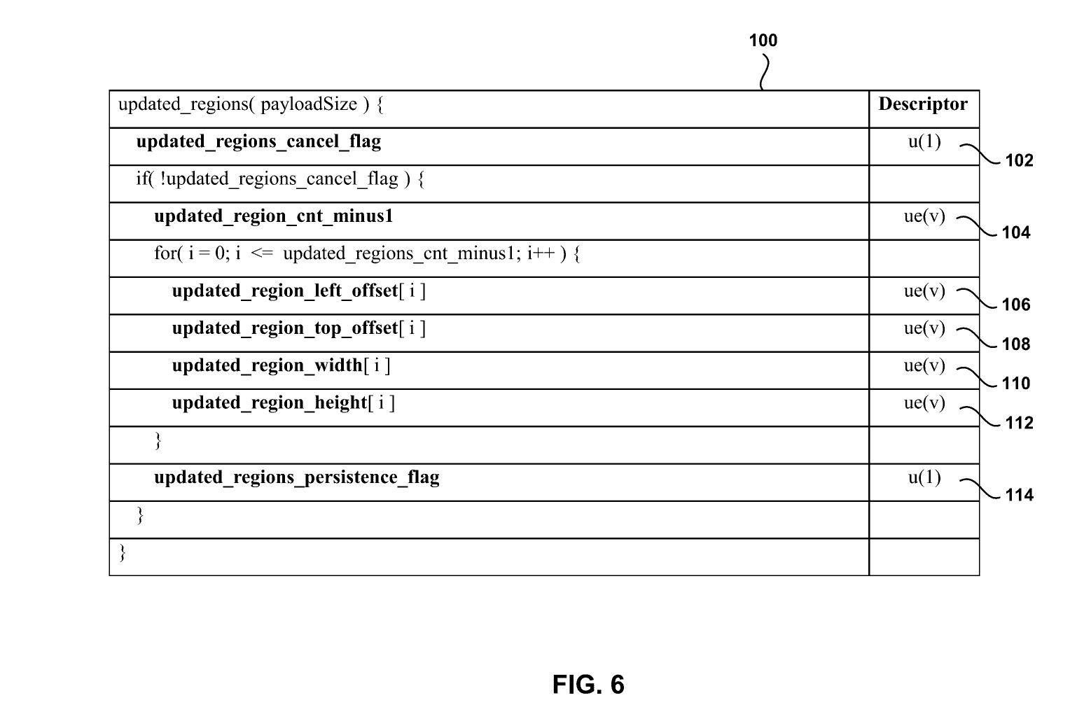

An example approach for conveying information used by a destination device 14, such as a smart display panel, to display only the updated portions of a frame is shown in FIG. 6. In the example approach of FIG. 6, an updated regions SEI message may be generated by updated region construction unit 66 to convey the information needed by the smart display panel at destination device 14.

SEI messages can be used to assist in processes related to, for instance, decoding and display. They are not required, however, under the HEVC specification, for constructing luma or chroma samples by the decoding process. In addition, conforming decoders are not required to process this information for output order conformance to the HEVC specification. In some example approaches, SEI message information is required to check bitstream conformance and for output timing decoder conformance.

SEI messages can be sent to destination device 14 via the bitstream, or can be transmitted to destination device 14 via other means not specified in the HEVC specification. When present in the bitstream, SEI messages must obey the syntax and semantics specified in clause 7.3.5 and Annex D. When the content of an SEI message is conveyed for the application by some means other than presence within the bitstream, the representation of the content of the SEI message is not required to use the same syntax specified in Annex D.

In the example updated regions SEI message 100 illustrated in FIG. 6, updated regions SEI message 100 indicates the rectangular regions, in the associated picture, in which the samples have different decoded sample values than the collocated samples in the previous picture in output order. The samples of the associated picture that are not in the indicated rectangular regions have the same decoded sample values as the collocated samples in the previous picture in output order.

In the example shown in FIG. 6, updated_regions_cancel_flag 102 equal to 1 indicates that the SEI message cancels the persistence of any previous updated regions SEI message in output order that applies to the current layer. Updated_regions_cancel_flag 102 equal to 0 indicates that updated regions information follows.

In the example shown in FIG. 6, updated_region_cnt_minus1 104 specifies the number of updated rectangular regions that are specified by the updated regions SEI message. In one example approach, the value of updated_region_cnt_minus1 104 may be in the range of 0 to 15, inclusive.

In the example shown in FIG. 6, updated_region_left_offset[i] 106, updated_region_top_offset[i] 108, updated_region_width[i] 110 and updated_region_height[i] 112, specify, as unsigned integer quantities in units of sample spacing relative to the luma sampling grid, the location of the i-th updated rectangular region.

In one example approach, the value of updated_region_rect_left_offset[i] 106 may be in the range of 0 to pic_width_in_luma_samples−1, inclusive. The value of updated_region_top_offset[i] 108 may be in the range of 0 to pic_height_in_luma_samples−1, inclusive. The value of updated region_width[i] 110 may be in the range of 1 to pic_width_in_luma_samples−updated_region_left_offset[i], inclusive. The value of updated_region_height[i] 112 shall be in the range of 1 to pic_height_in_luma_samples−updated_region_top_offset[i], inclusive.

In one example approach, the i-th rectangular updated region is specified, in units of sample spacing relative to a luma sampling grid, as the region with horizontal coordinates from updated_region_left_offset[i] 106 to pic_width_in_luma_samples−updated_region_right_offset[i]−1 and with vertical coordinates from updated_region_rect_top_offset[i] 108 to pic_height_in_luma_samples−pan_scan_rect_bottom_offset[i]−1, inclusive.

In the example shown in FIG. 4, updated_regions_persistence_flag 114 specifies the persistence of the updated regions SEI message for the current layer. When updated_regions_persistence_flag 114 equals 0, that specifies that the updated regions information applies to the current decoded picture only.

Let picA be the current picture. Then updated regions_persistence_flag equal to 1 specifies that the updated regions information persists for the current layer in output order until any of the following conditions are true:

A new CLVS of the current layer begins.

The bitstream ends.

A picture picB in the current layer in an access unit containing a updated regions SEI message and applicable to the current layer is output for which PicOrderCnt(picB) is greater than PicOrderCnt(picA), where PicOrderCnt(picB) and PicOrderCnt(picA) are the PicOrderCntVal values of picB and picA, respectively, immediately after the invocation of the decoding process for picture order count for picB.

In one example, video encoder 20 receives data indicating one or more regions of a current frame that have been updated, relative to a previous frame in display order. If the updated region is the same as a previous updated region, video encoder 20 sets the value of updated_regions_cancel_flag to false. After setting the value of updated_region_cancel_flag to false, video encoder 20 avoids coding values for any of the other flags, because the updated regions for a current image will be the same as the updated regions for a previously presented image in display order.

If the updated region is different for the current image relative to the previous image in display order, video encoder 20 sets the value of updated_regions_cancel_flag to true (e.g., “1”), determines a number of updated regions and sets a value for updated_region_cnt_minus1 equal to the number of updated regions minus one. As described above, in one example, for each region, video encoder 20 may determine a left-offset from a left edge of the picture to the left edge of the update region (e.g., in units of samples/pixels), a top-offset from a top edge of the picture to the top edge of the update region, a width of the update region, and a height of the update region, and sets these values in the SEI message accordingly. In another example, source device 12 may include one or more user interfaces by which a user may manually define regions of a picture that are updated that are subsequently used to generate SEI message, rather than having those regions being determined directly by video encoder 20 and then utilized to generate SEI message.

Thus, video encoder 20 sets the values of each of updated_region_left_offset[i] to a value representing the determined left-offset for an i^{th} region, updated_region_top_offset[i] to a value representing the determined top-offset for the i^{th} region, updated_region_width[i] to a value representing the determined width for the i^{th} region, and updated_region_height[i] to a value representing the determined height for the i^{th} region. Furthermore, video encoder 20 repeats this process for each of the number of updated regions. Finally, video encoder 20 sets a value for updated_regions_persistence_flag based on whether the updated regions information of the current SEI message persists beyond the current image.

Likewise, in one example, video decoder 30 receives the SEI message and provides the information within the SEI message to display device 32. For example, video decoder 30 may first determine whether the current SEI message cancels the updated region(s) of a previous updated regions SEI message based on the value of updated_regions_cancel_flag. If the updated_regions_cancel_flag has a value of false, video decoder 30 may determine that the updated regions remain the same as for a previously received updated regions SEI message, and therefore determine that subsequent data of the bitstream corresponds to a different data structure.

On the other hand, if the value of updated_regions_cancel_flag is true, video decoder 30 may proceed to determine a number of updated regions identified in the SEI message based on the value of updated_region_cnt_minus1. In particular, video decoder 30 may determine the number of regions identified in the SEI message as being equal to updated_region_cnt_minus1 plus 1. For each region i, video decoder 30 may determine the left-offset from the value of updated_region_left_offset[i], the top-offset from the value of updated_region_top_offset[i], the width from the value of updated_region_width[i], and the height from the value of updated_region_height[i].

Furthermore, video decoder 30 may determine whether the SEI message is applicable to images beyond the current image based on the value of updated_regions_persistence_flag. For example, if updated_regions_persistence_flag has a value of true, video decoder 30 may preserve the SEI message in memory for use when processing a subsequent image. Alternatively, if updated_regions_persistence_flag has a value of false, video decoder 30 may simply discard the SEI message from memory immediately after finishing processing of the current image.

Video decoder 30 may then, in one example, send data representing these values to display device 32. Alternatively, video decoder 30 may translate this information into vertices defining rectangles corresponding to the updated regions and send the information defining the vertices to display device 32. Alternatively, video decoder 30 may translate this information into an upper-left vertex, a width, and a height (or any other predetermined vertex), and provide this translated information to display device 32.

FIG. 7 illustrates a video source 18 with a frame 200 having a single updated region 202 that may be included when outputting video information to a destination device 14 having a display device 32. In one example approach, an SEI message transmits location information for the updated region to a display device 32. Video decoder 30 receives the SEI message, extracts the updated regions location information and presents both the location information corresponding to the updated region and video data corresponding to the non-updated region of the frame to display device 32. In one example approach, display device 32 may be a smart display panel. The smart panel display receives both the updated region display information and the video data corresponding to the non-updated region and displays both the updated region 206 and the video data corresponding to the non-updated region within the existing frame 204.

FIG. 8 is another example of outputting an updated region. In the example shown in FIG. 8, video source 18 includes a frame 200 having a single updated region 202. In one example approach, an SEI message transmits location information for the updated region to a display device 32. A video decoder 30 may receive the SEI message and the video data corresponding to the non-updated region, extracts the updated regions location information and presents the location information and the updated video data corresponding to the updated region and the video data corresponding to the non-updated region to display device 32. In one example approach, display device 32 is a smart display panel. Smart panel receives the updated region display information and the video corresponding to the updated region and displays the updated region 206 within the existing frame 204.

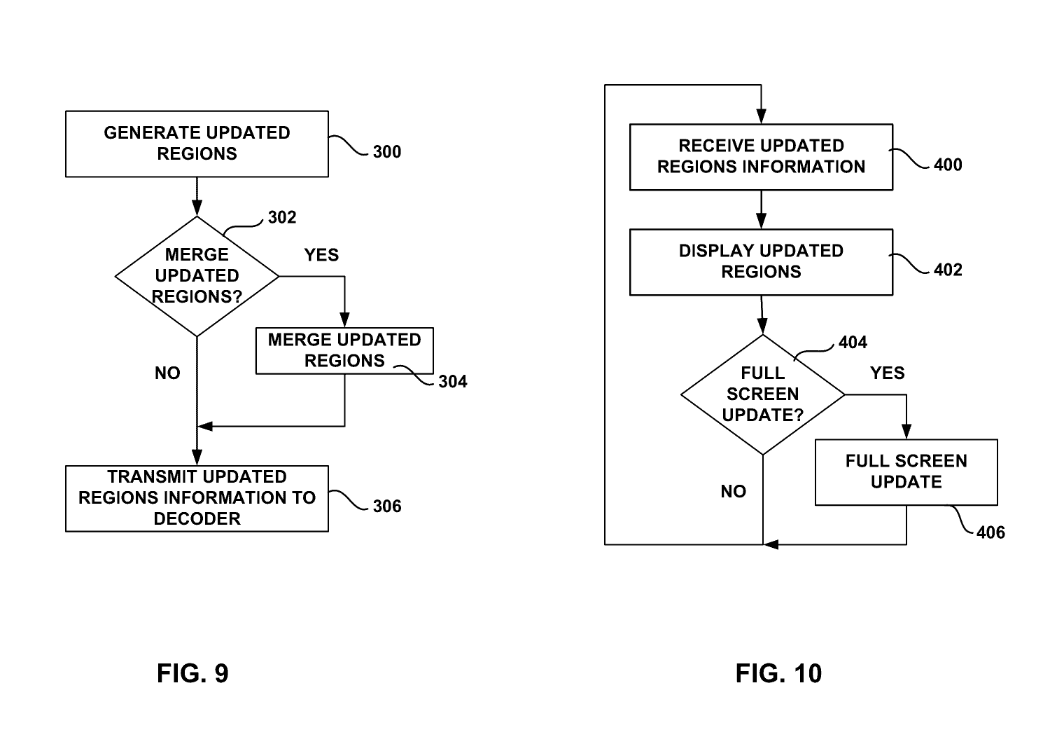

An example method of outputting information indicating a location of an updated region in a frame is shown in FIG. 9. In the example approach of FIG. 9, one or more updated regions of a frame are generated, wherein each updated region is less than the size of a full frame. (300) An updated regions message is generated by updated region construction unit 66 and transmitted to video decoder 30. in a display device. (306) In one example approach, source device 12 determines whether to merge one or more of the updated regions into a combined region. (302) If source device 12 determines to merge one or more of the updated regions into a combined region, a combined region is generated (304) and position information relevant to the combined region is transmitted. (306)

In one example approach, outputting the updated regions message includes encoding the updated regions message in the video bitstream.

In one example approach, the updated regions message is a picture level supplemental enhancement information (SEI) message. In one example approach, outputting the updated regions message includes encoding the SEI message in the video bitstream.

In some example approaches, the position information is transmitted via a slice header, a picture header, or a parameter set. Alternatively, the signaling can also be part of file format metadata according the ISO base media file format, e.g., in a time metadata track. Further alternatively, the signaling can be part of Real-time Transport Protocol (RTP) packets, such as in RTP header extensions or RTP payload data in communications based on RTP.

In one example approach, generating an updated regions message includes merging two or more updated regions of a frame into a combined updated region and writing region placement information corresponding to the combined updated region to the updated regions message.

An example method of displaying updated regions of a frame is shown in FIG. 10. In the example approach of FIG. 10, updated region extraction unit 84 of video decoder 30 may receive the updated region location information generated by updated region construction unit 66 of video encoder 20, extract the updated region information and transmit updated region placement information for identifying one or more updated regions in the current frame to video display device 32, in addition to the decoded video block formed by the video decoder 30 by summing of the residual blocks from inverse transform unit 78 with the corresponding predictive blocks generated by motion compensation unit 72. (400). Display device 32 updates a current display based on the data from the video bitstream corresponding to the updated regions within the frame and the updated regions placement information (402).

In one example approach, a check is made periodically to determine if a full screen update should be made. (404) If so, a full screen update is made. (406) In one example approach, processing is as follows:

A render engine generates the updated rectangles for UI layers.

Optionally, the composer merges all updated rectangles to into one larger updated region.

The encoder encodes updated regions SEI messages into the video bitstream.

The decoder parses updated regions SEI messages and the decoded video block formed by video decoder 30 by summing of the residual blocks from inverse transform unit 78 with the corresponding predictive blocks generated by motion compensation unit 72, and obtains information on the updated regions, and forwards the update region and the decoded video block to the display subsystem.

The display subsystem composes/transfers only samples in the updated regions.

Optionally, the display refreshes the full frame periodically to compensate for any errors, when present.

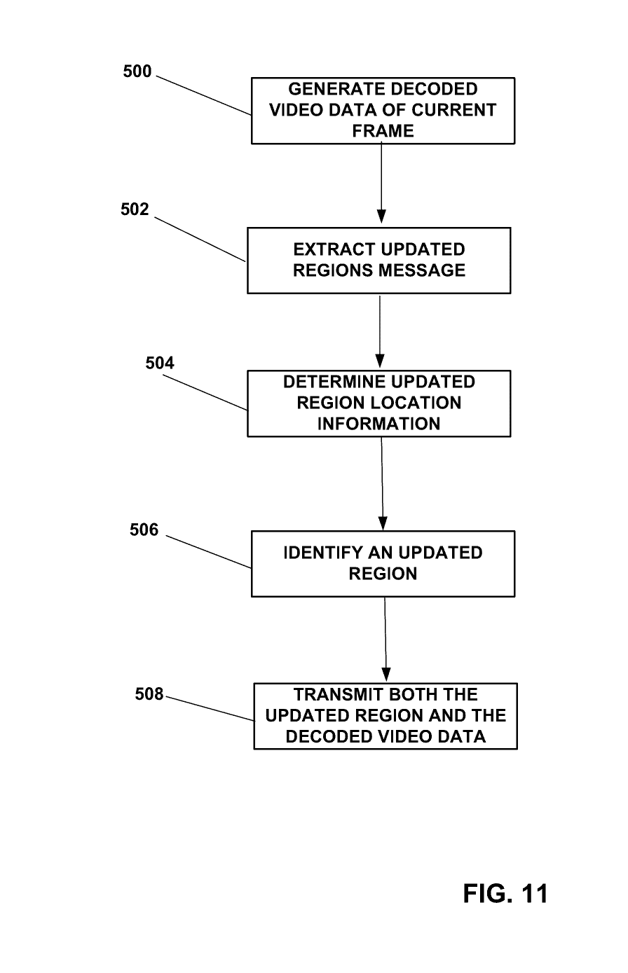

FIG. 11 is a flow chart of a method of decoding video data in accordance with techniques of the present disclosure. As illustrated in FIG. 11, in one example, a method of decoding video data includes video decoder 30 decoding the video data to generate decoded video data of a current frame of the video data (500). An updated regions message is extracted by updated region extraction unit 84 from the decoded video data (502) and updated region location information of the current frame is determined based on the updated regions message; (504). An updated region of the current frame is identified based on the updated region location information (506), the updated region being less than a total size of the current frame, and both the identified updated region and the decoded video data of the current frame are transmitted by the video decoder 30 (508).

For example, video decoder 30 may receive the SEI message from video encoder 20 and provide the information within the SEI message to display device 32. For example, video decoder 30 may simply extract the top offset, left offset, width, and height information from the SEI (502-506), and send data representing these values to display device 32 (508). Alternatively, video decoder 30 may translate the information within the SEI message into vertices defining rectangles corresponding to the updated regions. Alternatively, video decoder 30 may translate the information within the SEI message into an upper-left vertex, a width, and a height (or any other predetermined vertex), and provide this information to display device 32.

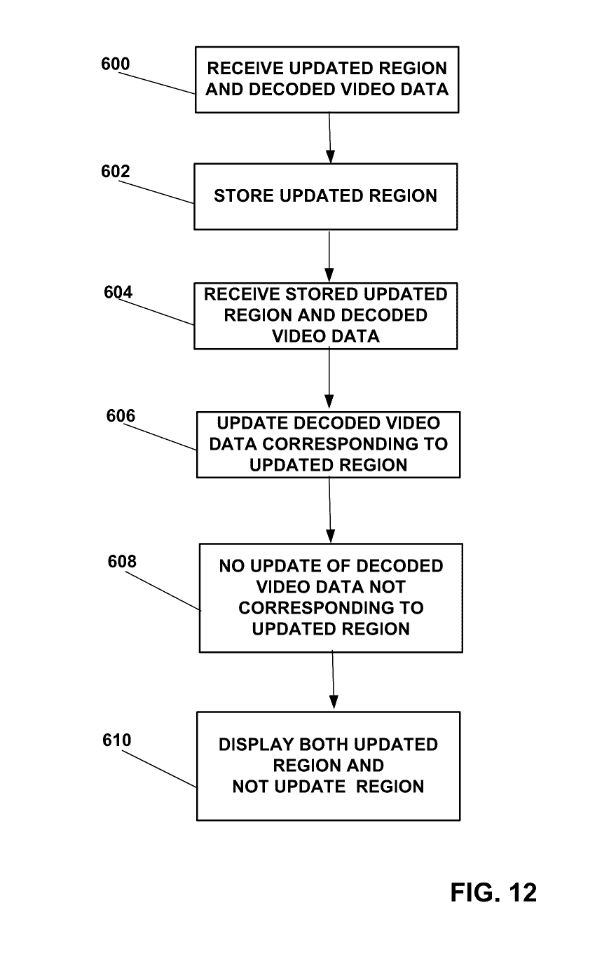

FIG. 12 is a flowchart of a method of generating a display by a display device in accordance with techniques of the present disclosure. As illustrated in FIG. 12, in one example, a method of decoding video data includes processing unit 85 of display device 32 within video decoder 30 receiving both the identified updated region and the decoded video data of the current frame (600), and storing the updated region in buffer 86 (602). Display processing unit 88 then receives the stored updated region and decoded video data (604), and updates decoded video data of the current frame corresponding to the updated region (606) and does not update decoded video data of the current frame not corresponding to the updated region (608). Display processing unit 88 then displays both the updated decoded video data of the current frame corresponding to the updated region, and decoded video data of the current frame corresponding to a region of the frame that is not updated (610), as illustrated in FIGS. 7 and 8, for example.

In one example, video decoder 30 may be configured to extract the updated region location information (e.g., the vertices defining one or more updated regions) from the SEI messages included in a bitstream that also includes the encoded video data. Video decoder 30 may then convert the extracted updated region location information to a different format that is usable by display device 32. Display device 32 may include a frame composition unit, as discussed above, and therefore, display device 32 may also be referred to as a frame composition device. In particular, display device 32 may be configured to generate (or compose) a frame including data from a previous frame in display order (that has not been updated in a current frame) and data from the current frame in display order (that has been updated relative to the previous frame).

More particularly, display device 32 may generate a frame to be displayed. To generate the frame, display device 32 may receive a decoded current frame and updated region location information from video decoder 30. Display device 32 may store video data from the decoded current frame included in the updated region identified by the updated region location information to the frame buffer 86, and video data from areas outside of the updated region from a previous frame (in display order) to the frame buffer 86. In this manner, a generated frame may include both data from the decoded current frame (specifically, for the updated region) as well as data from the previous frame (for regions outside the updated region). Thus, display processing unit 88 of display device 32 may ultimately display this generated frame.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. As used herein, the term ‘signaling’ may include storing or otherwise including data with an encoded bitstream. In other words, in various examples in accordance with this disclosure, the term ‘signaling’ may be associated with real-time communication of data, or alternatively, communication that is not performed in real-time.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
decoding the video data to generate decoded video data including a current frame;
extracting an updated regions message from the video data;
determining updated region location information of the current frame based on the updated regions message; and
outputting the updated region location information and the current frame.

2. The method of claim 1, wherein the current frame comprises one or more regions having only zero value motion vectors and a region having only non-zero value motion vectors, and wherein the updated regions comprises the one or more regions having only non-zero value motion vectors and excludes the one or more regions having only the zero value motion vectors.

3. The method of claim 1, further comprising displaying the current frame based on the updated region location information.

4. The method of claim 3, wherein displaying the current frame based on the identified updated region and the decoded video data of the current frame comprises:
storing the video data of the current frame in an updated region identified by the updated region location information to a frame of a frame buffer;
storing video data of a previous frame of the frame buffer outside the updated region to the frame of the frame buffer; and
displaying the frame.

5. The method of claim 1, wherein the updated regions message comprises extracting the updated regions message from at least one of a picture level supplemental enhancement information (SEI) message, a slice header of a slice included in the current frame, a picture header for a current frame, a parameter set encoded in a video bitstream including the current frame, metadata transmitted in a file conforming to an ISO base media file format and including the current frame, data of a Real-Time Protocol (RTP) header extension for an RTP transmission including the current frame, or an RTP payload including the current frame.

6. The method of claim 1, wherein determining updated region location information of the current frame based on the updated regions message comprises:
determining a left offset of an updated region within the current frame;
determining a top offset of the updated region within the current frame;
determining a height of the updated region within the current frame; and
determining a width of the updated region within the current frame.

7. The method of claim 1, wherein the updated region message is a picture level supplemental enhancement information (SEI) message comprising:
an updated_region_left_offset having a value representing a position of a left edge of an updated region of the current image corresponding to the updated region location information;
an updated_region_top_offset having a value representing a position of a top edge of an updated region of the current image corresponding to the updated region location information;
an updated_region_width having a value representing a width of an updated region of the current image corresponding to the updated region location information; and
an updated_region_height having a value representing a height of an updated region of the current image corresponding to the updated region location information.

8. The method of claim 7, wherein the updated_region_left_offset is within a range of 0 to pic_width_in_luma_samples−1, inclusive, the updated_region_top_offset is within a range of 0 to pic_height_in_luma_samples−1, inclusive, the updated_region_width is within a range of 1 to pic_width_in_luma_samples−updated_region_left_offset, inclusive, and the updated_region_height is within the range of 1 to pic_height_in_luma_samples−updated_region_top_offset, inclusive.

9. A device for decoding video data, comprising:
a memory configured to store video data; and
a video decoder comprising one or more processors implemented in digital logic circuitry, the video decoder configured to:
decode the video data to generate decoded video data including a current frame;
extract an updated regions message from the video data;
determine updated region location information of the current frame based on the updated regions message; and
output the updated region location information and the current frame.

10. The device of claim 9, wherein the current frame comprises both one or more regions having only zero value motion vectors and a region having only non-zero value motion vectors, and wherein the updated regions comprises the one or more regions having only non-zero value motion vectors.

11. The device of claim 9, further comprising a display unit comprising one or more processors configured to display the current frame based on the identified updated region and the decoded video data of the current frame.

12. The device of claim 11, wherein the display comprises a storage device, and wherein the one or more processors of the display unit are configured to store the identified updated region in the storage device, update decoded video data of the current frame corresponding to the stored identified updated region and not updating decoded video data of the current frame not corresponding to the updated region.

13. The device of claim 9, wherein extract the updated regions message comprises extracting the updated regions message from at least one of a picture level supplemental enhancement information (SEI) message, a slice header of a slice included in the current frame, a picture header for the current frame, a parameter set encoded in a video bitstream including the current frame, metadata transmitted in a file conforming to an ISO base media file format and including the current frame, data of a Real-Time Protocol (RTP) header extension for an RTP transmission including the current frame, or an RTP payload including the current frame.

14. The device of claim 9, wherein the video decoder is configured to:
determine a left offset of an updated region within the current frame;
determine a top offset of the updated region within the current frame;
determining a height of the updated region within the current frame; and
determining a width of the updated region within the current frame.

15. The device of claim 9, wherein the updated region message is a picture level supplemental enhancement information (SEI) message comprising:
an updated_region_left_offset having a value representing a position of a left edge of an updated region of the current image corresponding to the updated region location information;
an updated_region_top_offset having a value representing a position of a top edge of an updated region of the current image corresponding to the updated region location information;
an updated_region_width having a value representing a width of an updated region of the current image corresponding to the updated region location information; and
an updated_region_height having a value representing a height of an updated region of the current image corresponding to the updated region location information.

16. The device of claim 15, wherein the updated_region_left_offset is within a range of 0 to pic_width_in_luma_samples−1, inclusive, the updated_region_top_offset is within a range of 0 to pic_height_in_luma_samples−1, inclusive, the updated_region_width is within a range of 1 to pic_width_in_luma_samples−updated_region_left_offset, inclusive, and the updated_region_height is within the range of 1 to pic_height_in_luma_samples−updated_region_top_offset, inclusive.

17. A computer-readable medium storing instructions that, when executed, cause one or more processors to:
decode the video data to generate decoded video data of a current frame of the video data;
extract an updated regions message from the decoded video data and determining updated region location information of the current frame based on the updated regions message;
identify an updated region of the current frame based on the updated region location information, the updated region being less than a total size of the current frame; and
transmit both the identified updated region and the decoded video data of the current frame.

18. The computer-readable medium of claim 17, wherein the current frame comprises both one or more regions having only zero value motion vectors and a region having only non-zero value motion vectors, and wherein the updated regions comprises the one or more regions having only non-zero value motion vectors.

19. The computer-readable medium of claim 17, further comprising displaying the current frame based on the identified updated region and the decoded video data of the current frame.

20. The computer-readable medium of claim 19, wherein displaying the current frame based on the identified updated region and the decoded video data of the current frame comprises:
storing the identified updated region; and
updating decoded video data of the current frame corresponding to the updated region and not updating decoded video data of the current frame not corresponding to the updated region.

21. The computer-readable medium of claim 17, wherein extract the updated regions message comprises extracting the updated regions message from at least one of a picture level supplemental enhancement information (SEI) message, a slice header included in the current frame, a picture header for the current frame, a parameter set encoded in a video bitstream including the current frame, metadata transmitted in a file conforming to an ISO base media file format and including the current frame, data of a Real-Time Protocol (RTP) header extension for an RTP transmission including the current frame, or an RTP payload including the current frame.

22. The computer-readable medium of claim 17, wherein the computer-readable medium further cause the one or more processors to:
determine a left offset of an updated region within the current frame;
determine a top offset of the updated region within the current frame;
determining a height of the updated region within the current frame; and
determining a width of the updated region within the current frame.

23. The computer-readable medium of claim 17, wherein the updated region message is a picture level supplemental enhancement information (SEI) message comprising:
an updated_region_left_offset having a value representing a position of a left edge of an updated region of the current image corresponding to the updated region location information;
an updated_region_top_offset having a value representing a position of a top edge of an updated region of the current image corresponding to the updated region location information;
an updated_region_width having a value representing a width of an updated region of the current image corresponding to the updated region location information; and
an updated_region_height having a value representing a height of an updated region of the current image corresponding to the updated region location information.

24. The computer-readable medium of claim 23, wherein the updated_region_left_offset is within a range of 0 to pic_width_in_luma_samples−1, inclusive, the updated_region_top_offset is within a range of 0 to pic_height_in_luma_samples−1, inclusive, the updated_region_width is within a range of 1 to pic_width_in_luma_samples−updated_region_left_offset, inclusive, and the updated_region_height is within the range of 1 to pic_height_in_luma_samples−updated_region_top_offset, inclusive.

25. A device for generating a frame to be displayed, the device comprising:
a memory configured to buffer video data for one or more frames; and
one or more processors comprising digital logic circuitry, the processors being configured to:
store a previous frame to the memory;
receive a current frame from a video decoder;
receive updated region location information from the video decoder;
generate a frame including an updated region from the current frame identified by the updated region location information and a repeated region from the previous frame that is outside of the updated region; and
store the generated frame to the memory to cause the generated frame to be sent to a display.

26. The device of claim 25, wherein the processors are further configured to send the generated frame to the display.

27. The device of claim 25, wherein the updated region location information specifies a top edge of an updated region relative to a top edge of the current frame, a left edge of the updated region relative to a top edge of the current frame, a width of the updated region, and a height of the updated region.
